(19) United States
(12) Patent Application Publication
(10) Pub. No.: US 2022/0134636 A1
(43) Pub. Date: May 5, 2022

(54) METHOD FOR PRINTING A THREE-DIMENSIONAL OPTICAL COMPONENT

(71) Applicant: LUXEXCEL HOLDING B.V., Eindhoven (NL)

(72) Inventor: John-John Van Den Bergh, Eindhoven (NL)

(21) Appl. No.: 17/431,742

(22) PCT Filed: Feb. 19, 2020
(86) PCT No.: PCT/EP2020/054401

§ 371 Date: Aug. 18, 2021

(30) Foreign Application Priority Data
Feb. 20, 2019 (EP) 19158359.0

(51) Int. Cl. B29C 64/112; B29C 64/241; B29C 64/393; B29D 11/00; B29C 64/236

(52) U.S. Cl. CPC B29C 64/112; B29C 64/241; B29C 64/393; B33Y 10/00; B29C 64/236; B29D 11/00009; B29D 11/00951

(57) ABSTRACT

A method for printing a three-dimensional optical component (2) with an inkjet printer (1), wherein the three-dimensional component (2) is built up from layers of printing ink through a targeted placement of droplets (6) of printing ink at least partially side by side and one above the other in successive printing steps, wherein at least one printing step is followed by: a first scanning step during which surface properties of the two dimensional surface defined by the last printed layer are determined through a one dimensional measurement along a first direction by a measurement means (7), a rotation step during which the structure built up in the preceding steps is rotated with respect to the measurement means by a defined rotation angle and a second scanning step during which surface properties of the two-dimensional surface are determined through a one-dimensional measurement along a second direction by the measurement means.

### BACKGROUND

The present invention relates to a method for printing a three-dimensional optical component with an inkjet printer, wherein the three-dimensional component is built up from layers of printing ink through a targeted placement of droplets of printing ink at least partially side by side and one above the other in successive printing steps.

Printing three-dimensional optical components such as lenses, mirrors and the like is known from the prior art. The optical structures are built up layer by layer through a targeted placement of droplets of printing ink. The droplets are ejected towards a substrate by ejection nozzles of the print head of an inkjet printer. Through clogging or other technical defects, individual ejection nozzles may be inoperative or malfunctioning, resulting in a print of poor quality. To circumvent these and other printing errors, properties of the printed structure may be determined, identified and corrected immediately during the printing process.

Suchlike methods suffer from the drawback that they are either time consuming or involve costly equipment, resulting in longer printing cycles and higher printing costs.

### SUMMARY

It is a purpose of the present invention to provide a method for printing an optical three-dimensional component of high accuracy in a fast, efficient and costly manner as compared to methods known from the prior art. High accuracy in the print not only of the shape of the final structure, but also of its internal layered structure is particularly important for optical components as the internal structure determines the optical properties of the resulting component.

According to the present invention, this object is achieved by a method for printing a three-dimensional optical component with an inkjet printer, wherein the three-dimensional component is built up from layers of printing ink through a targeted placement of droplets of printing ink at least partially side by side and one above the other in successive printing steps, characterized in that at least one printing step is followed by a first scanning step during which surface properties of the two-dimensional surface defined by the last printed layer are determined through a one-dimensional measurement along a first direction by a measurement means, a rotation step during which the structure built up in the preceding steps is rotated with respect to the measurement means by a defined rotation angle and a second scanning step during which surface properties of the two-dimensional surface are determined through a one-dimensional measurement along a second direction by the measurement means. Preferably, the structure is rotated around an axis of rotation in the rotation step, wherein the axis of rotation is arranged perpendicular to a main extension plane of the two-dimensional surface defined by the last printed layer.

Herewith it is advantageously possible to detect printing errors directly during the printing process in a fast, efficient and cost-effective manner. In particular, the described method allows to infer deviations of the two-dimensional surface from its intended shape from two consecutive, one-dimensional measurements. This saves time and costs, as two-dimensional scans of the surface become superfluous. Likewise, costly equipment necessary to carry out measurements of the full two-dimensional surface is spared.

In the sense of the present invention, printed structure comprises the final three-dimensional optical component as well as all intermediates obtained during the printing process.

Preferably, wherein the first direction is the printing direction, i.e. the direction defined by the relative movement of a print head of the inkjet printer with respect to the printed structure and the rotation angle is 90°.

The one-dimensional measurement preferably comprises determination of the height profile of the two-dimensional surface along the first and second direction, respectively. The corresponding measurement means may be a line sensor. This has the advantage that the one-dimensional measurement along a first or second direction on the surface can be carried out in a single instance. Unfortunately, line sensors are costly. Therefore, the measurement means comprises a point sensor relative to which the printed structure is moved along the first and the second direction, respectively, in a preferred embodiment. In this way, identical information can be captured at a reduced production cost.

Another object of the present invention is a method for printing a three-dimensional optical component with an inkjet printer, wherein the three-dimensional structure is built up from layers of printing ink through a targeted placement of droplets of printing ink at least partially side by side and one above the other in successive printing steps, wherein at least one printing step is followed by a scanning step during which surface properties of the two-dimensional surface defined by the last printed layer are determined through a one-dimensional measurement by a measurement means, characterized in that the printed structure is rotated relative to the measurement means while the measurement is carried out. Preferably, the structure is rotated around an axis of rotation, wherein the axis of rotation is arranged perpendicular to a main extension plane of the two-dimensional surface defined by the last printed layer.

This advantageously provides an alternative method for detecting printing errors directly during the printing process in a fast, efficient and cost-effective manner, relying on measurement means apt at line- or pointwise measurements only.

The one-dimensional measurement comprises, e.g., determination of the height profile of the two-dimensional surface along at least one direction.

In a preferred embodiment, the printed structure is additionally moved relative to the measurement means in a direction perpendicular to the axis of rotation. Preferably, the printed structure is moved radially inwards in a first linear movement and then radially outwards in a second linear movement relative to the measurement means. Using a measurement means which comprises a point sensor, the entire surface of the printed structure can thus can scanned along a spiral path. Alternatively, the measurement means may comprise a line sensor.

Any of the previously described methods profits from tilting the measurement means with respect to the printed structure during the measurement, in order to avoid unfavorable reflection angles during measurement.

Another object of the present invention is a printer for carrying out a method as previously described. In particular, the printer comprises a print head, a printing plate, a measurement means and a motor, which drives a relative rotation of the printing plate with respect to the measurement means. In line with the above described methods, the measurement means preferably comprises a line sensor or a point sensor. The measurement means may additionally and preferably comprise a tilting device for adjusting the measurement angle to the height and shape of the printed structure. Preferably, the rotation is a rotation around an axis of rotation, wherein the axis of rotation is arranged perpendicular to the printing plate.

Herewith a printer is provided that allows printing of three-dimensional optical components with the benefits and advantages of the above described methods.

### BRIEF DESCRIPTION OF THE DRAWINGS

FIG. 1 schematically illustrates a printer according to an exemplary embodiment of the present invention.

FIG. 2 schematically illustrates a printing method according to an exemplary embodiment of the present invention.

FIG. 3 schematically illustrates a printing method according to an exemplary embodiment of the present invention.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In FIG. 1 a printer 1 according to an exemplary embodiment of the present invention is schematically illustrated. The printer 1 comprises a print head 3. From the ejection nozzles 4 of the print head 3, droplets 6 of printing ink are ejected towards the printing plate 5. A single row of nozzles 4 of the print head 3 ejects a single row of droplets 6 towards the printing plate 5, forming a row of printing ink on the printing plate 5. Through a relative movement of the print head 3 and the printing plate 5, a printing direction 11 is defined. Along this direction 11, droplets of printing ink are placed at least partially side by side to form a layer 10 of printing ink. The three-dimensional optical component 2 is built up from these layers 10. Droplets 6 of printing ink may be cured, e.g. through irradiation with ultra-violet (UV) light. Through curing, contaminations or technical defects, individual ejection nozzles may be malfunctioning or inoperative. In order to ensure that each printed layer as well as the overall printed structure has the intended shape, properties of the surface of the printed structure 2 are determined. To this end, the printer 1 comprises a measurement means 7. Preferably, the measurement means 7 comprises a sensor. This sensor may be a line sensor or, preferably, a point sensor. The measurement means 7 preferably comprises a means for determining the height profile of the printed structure 2. For example, the measurement means 7 comprises a sensor for confocal distance measurements. In order to obtain sufficient information on the shape of the printed layer 10 and thus the printed structure 2, the printer preferably comprises a motor 8 with which the printed structure 2 can be moved relative to the measurement means 7. This may involve moving the printed structure 2 through a movement of the printing plate 5. Alternatively, this involves moving the measurement means 7 and keeping the printing plate 5 and thus the printed structure 2 fixed. In a preferred embodiment, the measurement means 7 is hard mounted on the print head 3 and the printed structure 2 is moved through the motor by means of a movement of the printing plate 5. The motor 8 allows rotational and preferably also linear movement. In order to ensure measurements of sufficient accuracy during the entire printing process, the measurement means 7 is preferably mounted on a tilting device 9. As the height of the three-dimensional structure 2 increases during print, the inclination angle of the measurement means 7 with respect to the measured surface can be adjusted. In particular, an unfavorable reflection of the measurement beam emitted from the measurement means 7 can thus advantageously be avoided.

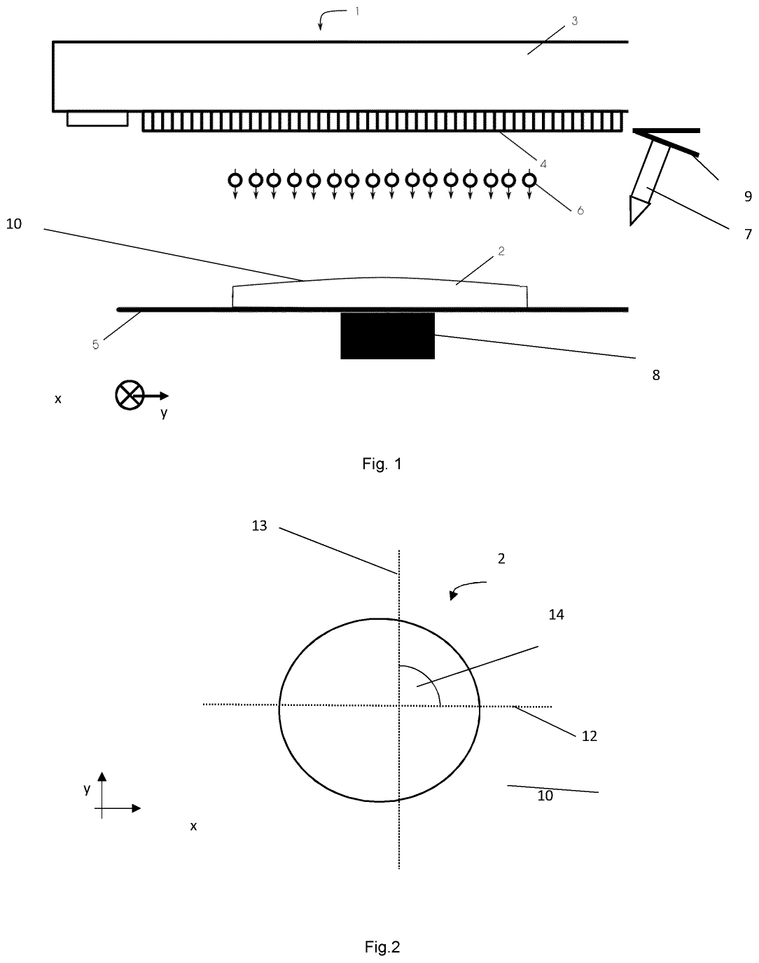

In FIG. 2 a method for printing a three-dimensional optical component 2 according to an exemplary embodiment of the present invention is schematically illustrated. The three-dimensional optical component 2 is built up layer by layer 10 through targeted placement of droplets 6 of printing ink at least partially side by side in successive printing steps. The droplets 6 of printing ink are ejected from the nozzles 4 of a print head of an inkjet printer towards a printing plate 5. The print head 3 is moved relative to the printing plate 5, thus defining the printing direction 11. For the sake of clarity, in the following a coordinate system is used for description, wherein the printing plate 5 constitutes the x-y-plane and the x-axis follows the printing direction 11. The relative movement in the sense of the present invention comprises a movement of the print head or a movement of the printing plate 5. After at least one printing step, a surface property of the last printed layer 10 is measured along a first direction 12 in a first scanning step. Preferably, the first direction 12 is the printing direction 11, thus conferring information on deviations along the printing direction 11. The measurement is a one-dimensional measurement, i.e. the information is collected along a line. Preferably, this line covers the entire length of the printed layer 10. The measurement is preferably carried out at a defined point on the y-axis. A malfunctioning ejection nozzle at this y-coordinate would result in a recurring deviation pattern in the measurement data. In a preferred embodiment, the measurement means 7 comprises a line sensor, preferably a line confocal sensor. A line confocal sensor advantageously allows a line measurement at a single instant. Unfortunately, suchlike line sensor are rather costly. Alternatively, the measurement means 7 comprises a point sensor, e.g. a point confocal sensor. To obtain a one-dimensional measurement with this type of sensor, the measurement means 7 has to be moved linearly relative to the printed layer 10. This relative movement involves either a movement of the printing plate 5 or a movement of the measurement means 7. In this way, a cost-effective measurement means 7 for one-dimensional measurements is provided. After the first scanning step, the printed structure 2 is rotated, e.g. via the printing plate 5, relative to the measurement means 7. The relative rotation may involve a movement of the measurement means 7 or a movement of the printed structure 2. Preferably, the rotation angle 14 is 90°. At this angle 14, a second scanning step is carried out. During this scanning step, information on the surface properties of the layer 10 along a second direction 13 is gathered through a one-dimensional measurement. Preferably, the measurement is similar to the measurement during the first scanning step. The second direction 13 is hence preferably along the y-axis, i.e. perpendicular to the printing direction 11. Thus, the second scanning step provides information on whether an ejection nozzle 4 is malfunctioning. Preferably, the first and second scanning steps are carried out after a layer 10 has been finished. The scanning steps may be carried out after every finished layer 10 or at certain interval, depending on the required speed and accuracy. In a preferred embodiment, the tilting angle of the measurement means 7 is adjusted depending on the shape the and height of the printed structure 2 in order to ensure measurement results of sufficiently high accuracy. E.g. the measurement means 7 is tilted such that the measurement beam of the measurement means 7 has the optimal angle of incidence.

Preferably, the measurement results from the first and second scanning steps are analysed and converted into an error map. The error map contains information on the measured deviations of the layer 10. The remaining printing process is preferably determined by this information. E.g. the printing may be halted and the structure 2 printed so far may be discarded. Preferably, this is the case if the deviations cannot be healed or corrected by further printing or curing steps. Alternatively, the error map is preferably superimposed on the printing data. The updated printing data account for the measured errors such that these are corrected through the following printing steps. The correction of errors is preferably obtained over a number of printing steps and not in a single step as otherwise optical deficiencies may result. Preferably, the error cancelation involves ten successive layers 10. In this way, a method is advantageously provided that allows a fast, efficient and cost-effective measurement step, ensuring high quality of the resulting optical structure 2. In particular, the high accuracy in the layered structure necessary for the printing of three-dimensional optical components 2 is achieved.

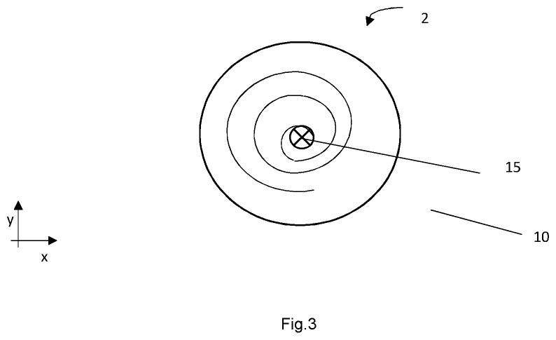

In FIG. 3 a method for printing a three-dimensional optical component 2 according to an exemplary embodiment of the present invention is schematically illustrated. The method described here differs from the one of FIG. 2 in the scanning step. Instead of two successive scanning steps with orthogonal scanning directions, in this method the entire surface of the layer 10 is advantageously scanned. To his end, the printed structure 2 is rotated relative to the measurement means 7. The measurement means 7 is preferably a point sensor, e.g. a point confocal sensor. This point sensor 7 is additionally moved linearly relative to the printed structure 2 in a direction perpendicular to the axis of rotation 15. In a preferred embodiment, the measurement means 7 is moved radially inward while the printed structure 2 is rotated. The measurement means 7 thus scans an inwards pointing spiral path on the surface of the layer 10. After arriving at the axis of rotation 15, the measurement means 7 preferably moves outwards, scanning the surface of the layer 10 in an outwards pointing spiral path. In this way, the layer 10 is densely scanned for deviations and printing errors. A full error map can hence be advantageously be obtained. In the embodiment according to which the measurement means 7 comprises a confocal point distance sensor, a height profile of almost the entire surface of the layer 10 is obtained. Preferably, the scanning step is carried out after each finishing of each layer 10. Preferably this is done, if the speed of rotation is 300 rpm or larger. At lower rotational speed, the scanning step may be carried out only every other layer or at other, suitable intervals. Preferably, the axis of rotation 15 is arranged perpendicular to a main extension plane of the two-dimensional surface defined by the last printed layer.

### KEY TO FIGURES

1 Printer
2 Printed three-dimensional component, printed structure
3 Print head
4 Ejection nozzle
5 Printing plate
6 Droplet of printing ink
7 Measurement means
8 Motor
9 Tilting device
10 Layer
11 Printing direction
12 First measurement direction
13 Second measurement direction
14 Rotation angle
15 Rotation axis

1. A method for printing a three-dimensional optical component with an inkjet printer, wherein the three-dimensional component is a printed structure built up from layers of printing ink through a targeted placement of droplets of printing ink at least partially side by side and one above the other in successive printing steps, wherein a print head is moved relative to a printing plate, thus defining a printing direction, wherein the printing plate constitutes an x-y plane and an x-axis follows the printing direction, wherein at least one printing step is followed by:
a scanning step during which surface properties of the two-dimensional surface defined by a last printed layer are determined through a one-dimensional measurement by a measurement means,
wherein the printed structure is rotated relative to the measurement means while the measurement is carried out.

2.-7. (canceled)

8. The method according to claim 1 wherein the one-dimensional measurement comprises determination of a height profile of the two-dimensional surface along at least one direction.

9. The method according to claim 1, wherein the printed structure is moved relative to the measurement means in a direction perpendicular to an axis of rotation.

10. The method according to claim 9, wherein the printed structure is moved radially inwards in a first linear movement and then radially outwards in a second linear movement relative to the measurement means.

11. The method according to claim 1, wherein the measurement means comprises a point sensor.

12. The method according to claim 1, wherein the measurement means comprises a line sensor.

13. The method according to claim 1, wherein the measurement means is tilted with respect to the printed structure during the measurement.

14.-16. (canceled)
